(19) United States
(12) Patent Application Publication
(10) Pub. No.: US 2010/0077590 A1
(43) Pub. Date: Apr. 1, 2010

(54) Die pickup method

(75) Inventors: Kazuhiro Fujisawa, Nishitokyo-shi (JP); Yutaka Odaka, Akiruno-shi (JP)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: Kabushiki Kaisha Shinkawa

(21) Appl. No.: 12/592,624

(22) Filed: Nov. 30, 2009

Related U.S. Application Data
(62) Division of application No. 11/134,752, filed on May 20, 2005.

(30) Foreign Application Priority Data
May 17, 2004 (JP) 2004-145837
May 31, 2004 (JP) 2004-160407

(51) Int. Cl. B23P 11/00; B23P 19/00

(52) U.S. Cl. 29/426.1; 29/762

(57) ABSTRACT

A die push-up apparatus using a vertically movable die pick-up member 22 for die-peeling, the die pick-up member 22 which pushes dies upward being disposed inside a suction holding stage 10 further toward a die feeding direction side than a die push-up member 21 for die-pickup. With the die push-up member 22 lowered, the forward end portion (with respect to the die feeding direction) of a die 1A that is to be picked up is moved to above the die push-up member 22, the die push-up member 22 is next raised so that the forward end portion of the die 1A passing thereon is peeled from the wafer sheet 2; and further with the die push-up member 22 raised, the die 1A is fed to the pickup center 5 and is picked up by a collet 4 and the rising die push-up member 21.

### BACKGROUND OF THE INVENTION

1. Field of the Invention

The present invention relates to a die pickup apparatus that picks up dies from a wafer sheet by a collet.

2. Description of the Related Art

The push-up member system described in Japanese Patent Application Laid-Open (Kokai) No. H3-229441 is generally used as a pickup apparatus for dies pasted to a wafer sheet. In this apparatus, however, the problem of die damage may be encountered in cases where the thickness of the dies is approximately 100 μm or less.

Japanese Patent Application Laid-Open (Kokai) No. 2001-118862 (Japanese Patent No. 3209736) discloses measures to alleviate this problem. In other words, this prior art discloses a method for picking up dies from a wafer sheet without using any die push-up elements. In this apparatus, while suction is applied by a suction holding stage to a wafer sheet (which is a bonding sheet) to which dies are pasted, the suction holding stage is moved on the horizontal plane with a die held by a collet, after which the collet picks up the die from the wafer sheet.

The problem in the apparatus of the above-described Japanese Patent Application Laid-Open (Kokai) No. H3-229441 is that it causes damages to the dies; however, the technique in this apparatus is advantageous in that there are almost no die pickup errors. In the apparatus of Japanese Patent Application Laid-Open (Kokai) No. 2001-118862 (Japanese Patent No. 3209736) any die damage is prevented. However, since the bonded wafer sheet and dies are respectively held by vacuum suction of a suction holding stage and collet, and the wafer sheet and the dies are separated by causing the suction holding stage to move horizontally, it is necessary to strengthen the vacuum suction force, and this causes the problem of a deleterious effect on the dies.

### SUMMARY OF THE INVENTION

The object of the present invention is to provide a die pickup apparatus which securely picks up dies without damaging the dies even when a die push-up member is used.

The above object is accomplished by a unique structure of the present invention for a die pickup apparatus that includes: a suction holding stage that suction-holds a wafer sheet on which dies are pasted, a die push-up member used for die-pickup which is disposed in the suction holding stage and pushes up a die, and a collet which suction-holds a die that is pushed up by the die push-up member used for die-pickup and which conveys the die; and in the present invention,
a die push-up member used for die-peeling which pushes up the die is installed inside the suction holding stage on a die feeding side (or downstream side) with respect to the die push-up member used for die-pickup so that the die push-up member used for die-peeling is movable upward and downward; and the die pickup apparatus,
with the die push-up member used for die-peeling lowered, moves the end portion of a die which is to be picked up located on the die feeding direction side to above the die push-up member used for die-peeling,
raises the die push-up member used for die-peeling so that the end portion of the die located on the die feeding direction side is peeled from the wafer sheet,
subsequently feeds the die with the die push-up member used for die-peeling raised, so that the die is partially or entirely peeled, and then
allows the collet to pick up the die.

The above object is accomplished by another unique structure of the present invention for a die pickup apparatus that includes: a suction holding stage that suction-holds a wafer sheet on which dies are pasted, a die push-up member used for die-pickup which is disposed in the suction holding stage and pushes up a die, and a collet which suction-holds a die that is pushed up by the die push-up member used for die-pickup and which conveys the die; and in the present invention,
a die push-up member used for die-peeling which pushes up the die is installed inside the suction holding stage on a die feeding side with respect to the die push-up member used for die-pickup so that the die push-up member used for die-peeling is movable upward and downward; and the die pickup apparatus,
with the die push-up member used for die-peeling lowered, moves the end portion of a die which is to be picked up located on the die feeding direction side to above the die push-up member used for die-peeling,
raises the die push-up member used for die-peeling so that the end portion of the die located on the die feeding direction side is peeled from the wafer sheet,
subsequently feeds the die after the die push-up member used for die-peeling is lowered, so that the die is partially or entirely peeled, and then
allows the collet to pick up the die.

The above object is accomplished by still another unique structure of the present invention for a die pickup apparatus that includes: a suction holding stage that suction-holds a wafer sheet on which dies are pasted, a die push-up member used for die-pickup which is disposed at a pickup center in the suction holding stage and pushes up a die, and a collet which suction-holds a die that is pushed up by the die push-up member used for die-pickup and which conveys the die; and in the present invention,
a suction hole is formed in the upper surface of the suction holding stage on the die feeding side with respect to the die push-up member used for die-pickup; and the die pickup apparatus,
with the die push-up member used for die-pickup lowered, moves the end portion of a die which is to be picked up located on the die feeding direction side to above the die push-up member used for die-pickup,
raises the die push-up member used for die-pickup so that the end portion of the die located on the die feeding direction side is peeled from the wafer sheet,
subsequently causes the die to move while riding over the die push-up member used for die-pickup with the die push-up member used for die-pickup remaining in a raised position,
feeds back the die to the pickup center, and then
allows the collet to pick up the die.

The above object is accomplished by still another unique structure of the present invention for a die pickup apparatus that includes: a suction holding stage that suction-holds a wafer sheet on which dies are pasted, a die push-up member used for die-pickup which is disposed at a pickup center in the suction holding stage and pushes up a die, and a collet which suction-holds a die that is pushed up by the die push-up member used for die-pickup and which conveys the die; and in the present invention,
a suction hole is formed in the upper surface of the suction holding stage on the die feeding side with respect to the die push-up member used for die-pickup; and the die pickup apparatus,
with the die push-up member used for die-pickup lowered, moves the end portion of a die which is to be picked up located on the die feeding direction side to above the die push-up member used for die-pickup,
raises the die push-up member used for die-pickup so that the end portion of the die located on the die feeding direction side is peeled from the wafer sheet,
subsequently lowers the die push-up member used for die-pickup and moves the die end portion located on the die feeding direction side to above the suction hole,
fees back the die to the pickup center, and then
allows the collet to pick up the die.

The above object is accomplished by a further unique structure of the present invention for a die pickup apparatus that includes: a suction holding stage that suction-holds a wafer sheet on which dies are pasted, a die push-up member used for die-pickup which is disposed at a pickup center in the suction holding stage and pushes up a die, and a collet which suction-holds a die that is pushed up by the die push-up member used for die-pickup and which conveys the die; and in the present invention,
a suction hole is formed in the upper surface of the suction holding stage on the die feeding side with respect to the die push-up member used for die-pickup; and the die pickup apparatus,
moves the end portion of a die which is to be picked up located on the die feeding direction side to above the suction hole,
applies vacuum suction to the suction holding stage so that the end portion of the die located on the die feeding direction side is peeled from the wafer sheet,
subsequently feeds back the die to the die pickup center, and then
allows the collet to pick up the die.

According to the present invention, since the bonding strength between the die that is sent to the pickup center and the wafer sheet is reduced, no damage would occur to the die, which is thin, even if the die is pushed up by die push-up members.

### BRIEF DESCRIPTION OF THE DRAWING

FIG. 1 is a sectional front view showing the steps of the first embodiment of the die pickup apparatus of the present invention;

FIG. 2 is a to view of the suction holding stage used in the first embodiment of FIG. 1;

FIG. 3 is a sectional front view showing the steps of the second embodiment of the die pickup apparatus of the present invention;

FIG. 4 is a sectional front view showing the steps of the third embodiment of the die pickup apparatus of the present invention;

FIG. 5 is a sectional front view showing the steps of the fourth embodiment of the die pickup apparatus of the present invention;

FIG. 6 is a sectional front view showing the steps of the fifth embodiment of the die pickup apparatus of the present invention;

FIG. 7 is a sectional front view showing the steps of the sixth embodiment of the die pickup apparatus of the present invention;

FIG. 8 is a sectional front view showing the steps of the seventh embodiment of the die pickup apparatus of the present invention;

FIG. 9 is a sectional front view showing the steps of the eighth embodiment of the die pickup apparatus of the present invention.

### DETAILED DESCRIPTION OF THE INVENTION

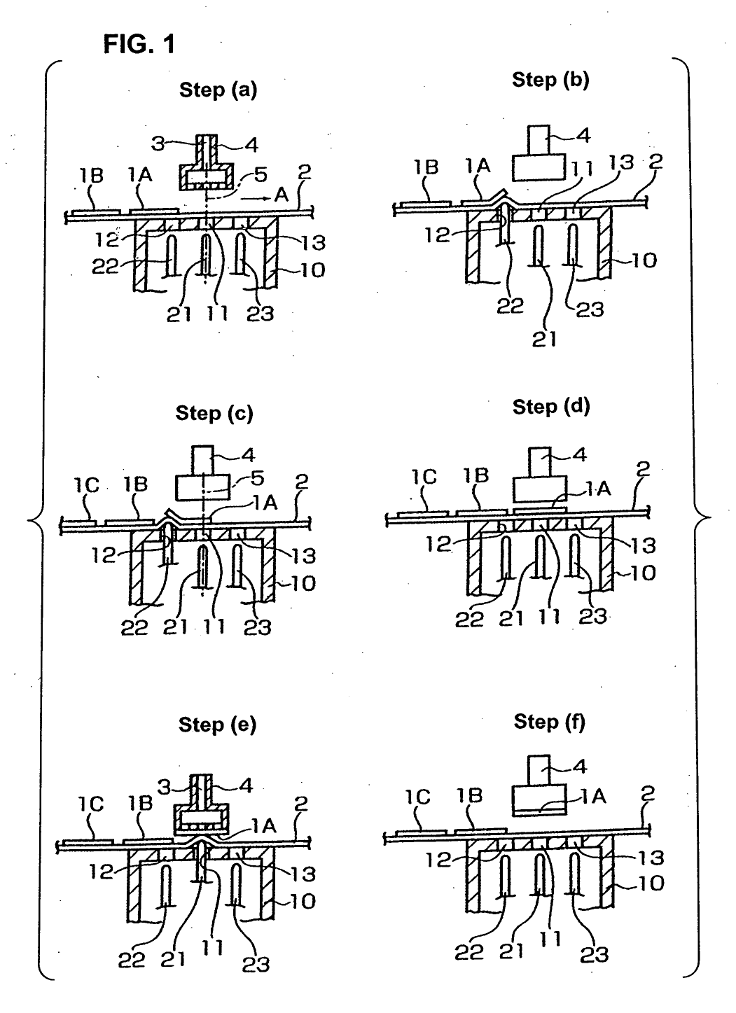

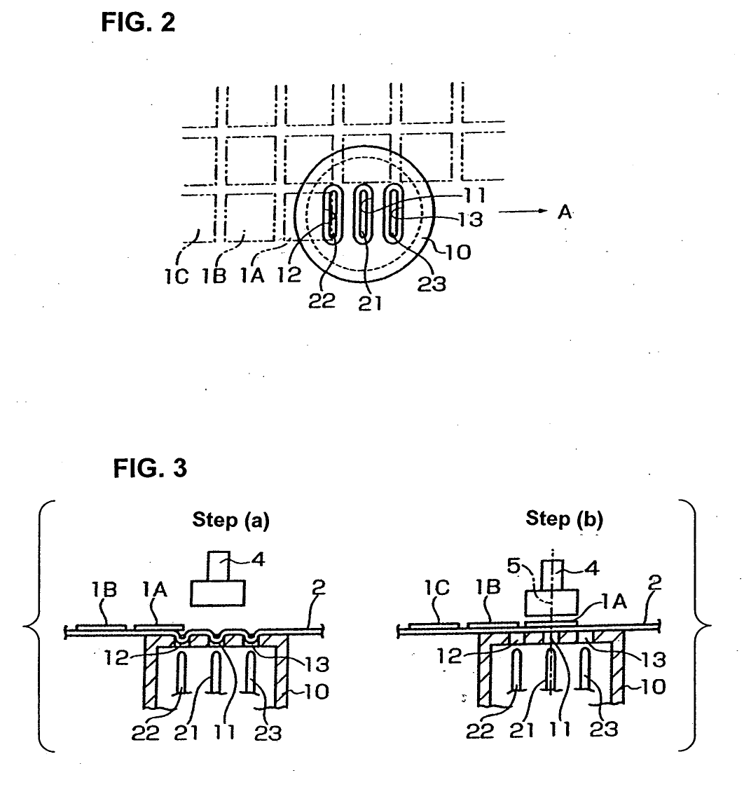

A first embodiment of the die pickup apparatus of the present invention will be described with reference to FIGS. 1 and 2.

As seen from the step (a) in FIG. 1, a wafer sheet 2 has dies 1A, 1B, 1C . . . pasted thereon, and the outer circumference of the wafer sheet 2 is fastened to a wafer ring (not shown in the drawings). The wafer ring is fastened to a wafer supporting frame (not shown in the drawings) which is driven horizontally in the directions of the X and Y axes. The dies 1A, 1B, 1C . . . are vacuum suction-held and picked up by a collet 4 that has a suction holding hole 3 in it. A suction holding stage 10 which suction-holds the wafer sheet 2 by means of vacuum suction is provided beneath the pickup center 5. This structure is known well.

A die push-up member 21 used for die-pickup is disposed at the pickup center 5 inside the suction holding stage 10 so that this die push-up member 21 is movable upward and downward. Die push-up members 22 and 23 used for die-peeling are disposed on both sides of this die push-up member 21 so that these die push-up members 22 and 23 are movable upward and downward.

These die push-up members 21, 22 and 23 have a flat plate shape, and they can be independently driven upward and downward by raising and lowering driving means which is not shown in the drawings.

As shown in FIG. 2, the die push-up members 21, 22 and 23 are formed so that the lengths of these members in the direction perpendicular to the wafer sheet feeding direction A fall to the inside of the corner portions of the dies 1A, 1B, 1C, . . . i.e., so that these die push-up members are shorter than the lengths of the sides of the dies 1A, 1B, 1C . . . Suction holes 11, 12 and 13 that act both as through-holes for the die push-up members 21, 22 and 23 and as suction holes for the wafer sheet 2 are formed in the suction holding stage 10.

Next, the die pickup method will be described with reference to FIG. 1.

In step (a), the vacuum of the suction holding stage 10 is switched on, and the wafer ring (not shown in the drawings) to which the wafer sheet 2 is fastened is moved so that the end portion (leading edge portion) (with respective to the die feeding direction A) of the die 1A that is to be picked up is moved to above the die push-up member 22.

Next, in step (b), the die push-up member 22 is raised, so that it pushes up the end portion of the die 1A with respective to the die feeding direction via the wafer sheet 2. As a result, the end portion of the die 1A with respective to the die feeding direction is peeled from the wafer sheet 2.

Next, in step (c), with the die push-up member 22 still raised, the wafer sheet 2 is moved so that the die 1A is positioned at the pickup center 5. When the die 1A passes over the die push-up member 22, the die 1A is fed so that it rides over the peak portion which is pushed upward by the die push-up member 22; accordingly, the bonding strength between the wafer sheet 2 and die 1A drops.

Next, in step (d), the die push-up member 22 is lowered and separated from the wafer sheet 2, and the collet 4 is lowered to a position where this collet 4 suction-holds the die 1A.

Then, in step (e), the die push-up member 21 is raised so that the die push-up member 21 pushes the die 1A upward, and the collet 4 catches and holds the die 1A by vacuum suction. In this case, since the bonding strength between the wafer sheet 2 and the die 1A has been lowered, the die 1A can easily be peeled from the wafer sheet 2 by the upward movement of the die push-up member 21 without being damaged.

The collet 4 that has picked up the die 1A by vacuum suction is moved upward and in the directions of the X and Y axes by a conveying means not shown in the drawings, and the next process, e.g., a process of die bonding, die packing or the like, is performed.

When the die 1A is picked up, the die push-up member 21 is lowered in step (0, and the wafer sheet 2 is caused to move so that the end portion (leading edge portion) (with respective to the die feeding direction) of the die 1B that is to be picked up next is moved to above the die push-up member 22 as described above.

As seen from the above, since the bonding force between the wafer sheet 2 and the die 1A fed to the pickup center 5 has been lowered, the die 1A, which is thin, is not damaged when the die is pushed upward by the die push-up member 21.

In the above-described embodiment, the die push-up member 23 does not make any action at all. The reason for this is that the embodiment is described so that a die is conveyed to the pickup center 5 from the left side in FIG. 1. In cases where a die is conveyed to the pickup center 5 from the right side, the die push-up member 23 acts in the same manner as the die push-up member 22 described above, and the die push-up member 22 does not act.

The second embodiment of the die pickup apparatus of the present invention will be described with reference to FIG. 3. The second embodiment is a modification of the first embodiment; and in this second embodiment, the steps (c) and (d) in FIG. 1 are replaced with the steps (a) and (b) shown in FIG. 3. The rest of the steps of the second embodiment are the same as the steps shown in FIG. 1, and only the steps that are different will be described below.

Following the step (a) in FIG. 1, the end portion (leading edge portion) (with respective to the die feeding direction A) of the die 1A is pushed upward by the die push-up member 22 in step (b) in FIG. 1, so that the end portion of the die 1A is peeled from the wafer sheet 2.

Then, step (a) of FIG. 3 is taken; in other words, the die push-up member 22 is lowered.

Subsequently, in step (b) shown in FIG. 3, the wafer sheet 2 is moved so that the die 1A is positioned at the pickup center 5. Since the end portion of the die 1A has been peeled from the wafer sheet 2 as described above, the die 1A is peeled from the wafer sheet 2 by the vacuum suction force of the suction hole 12 when the die 1A is moved in step (a) and step (b) in FIG. 3, so that the bonding strength between the wafer sheet 2 and die 1A is lowered.

Subsequently, the steps (e) and (f) shown in FIG. 1 are performed.

In this embodiment, since the bonding strength between the wafer sheet 2 and the die 1A conveyed to the pickup center 5 has been lowered, the die 1A, which is thin, is not damaged when the die 1A is pushed up by the die push-up member 21.

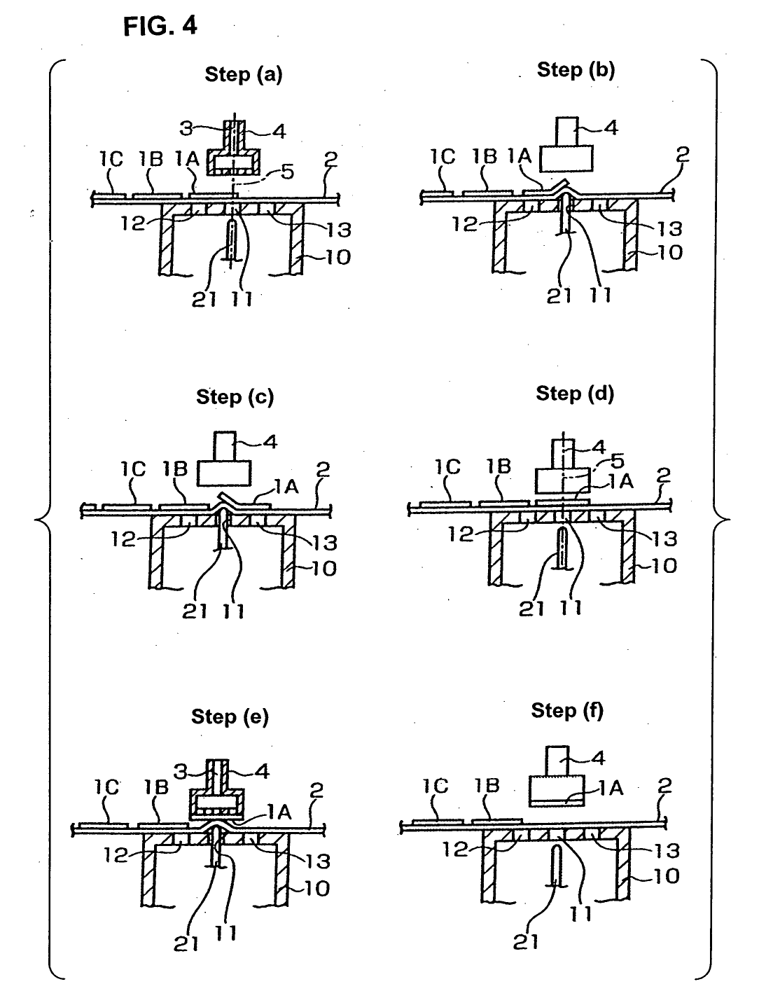

The third embodiment of the die pickup apparatus of the present invention will be described with reference to FIG. 4.

Below, the members, which are the same as those in FIGS. 1 through 3 or correspond to the those in FIGS. 1 through 3, are labeled with the same symbols, and a detailed description of such members is omitted.

In this embodiment shown in FIG. 4, a die push-up member 21 is disposed at the pickup center 5, and only the suction holes 12 and 13 are provided on both sides of the suction hole 11 of this die push-up member 21. Die push-up members 22 and 23 are not provided in the suction holes 12 and 13.

The die pickup method shown in FIG. 4 will be described.

In step (a), the vacuum of the suction holding stage 10 is switched on, and the wafer sheet 2 is moved so that the end portion (leading edge portion) (with respective to the die feeding direction) of the die 1A that is to be picked up is moved to above the die push-up member 21.

Next, in step (b), the die push-up member 21 is raised, so that the end portion of the die 1A is pushed upward via the wafer sheet 2. As a result, the end portion (with respect to the die feeding direction) of the die 1A is peeled from the wafer sheet 2.

In the next step (c), with the die push-up member 21 remaining in a raised position, the wafer sheet 2 is moved so that the die 1A rides over the die push-up member 21. When the die 1A passes over the die push-up member 21, the die 1A is fed so that it rides over the peak portion pushed upward by the die push-up member 21; accordingly, the bonding strength between the wafer sheet 2 and die 1A drops.

Subsequently, in step (d), the die push-up member 21 is lowered, and the wafer sheet 2 is moved so that the die 1A is positioned at the pickup center 5.

In step (e), the die push-up member 21 is raised so that the die 1A is pushed upward, and the collet 4 holds the die 1A by vacuum suction. In this case, since the bonding strength between the wafer sheet 2 and the die 1A has been lowered, the die 1A can easily be peeled from the wafer sheet 2 by the upward movement of the die push-up member 21, so that the die 1A is not damaged.

The collet 4 that has picked up the die 1A by vacuum suction is moved upward and in the directions of the X and Y axes by a conveying means which is not shown in the drawings, and the next process, e.g., a process of die bonding, die packing or the like, is performed.

When the die 1A is picked up, the die push-up member 21 is lowered in step (f), and the wafer sheet 2 is caused to move so that the end portion (leading edge portion) (with respective to the die feeding direction) of the die 1B that is to be picked up next is moved to above the die push-up member 21 in the same manner as described above (see step (a)).

As seen from the above, since the bonding force between the wafer sheet 2 and the die 1A fed-back to the pickup center 5 in step (d) has been lowered, the die 1A, which is thin, is not damaged when the die is pushed upward by the die push-up member 21.

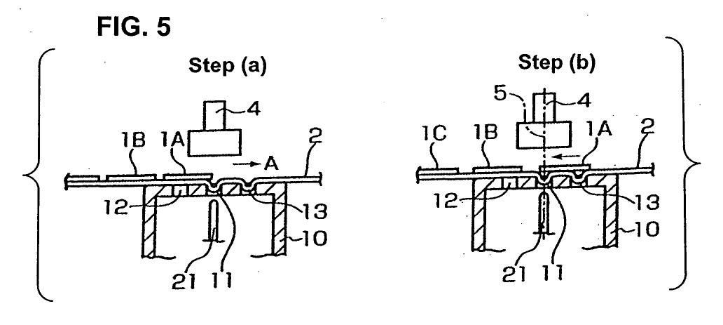

A fourth embodiment of the die pickup apparatus of the present invention will be described with reference to FIG. 5. The fourth embodiment is a modification of the third embodiment, and the steps (c) and (d) of FIG. 4 are replaced with the steps (a) and (b) shown in FIG. 5. The rest of the steps of this embodiment are the same as the steps shown in FIG. 4, and only the steps that are different will be described.

Following the step (a) in FIG. 4, the end portion (leading edge portion) (with respect to the die feeding direction) of the die 1A is pushed upward by the die push-up member 21 in step (b), so that this end portion of the die 1A is peeled from the wafer sheet 2.

Then, as shown in step (a) of FIG. 5, the die push-up member 21 is lowered, and the die 1A is fed in the die feeding direction A so that all or part of the die 1A is peeled from the wafer sheet 2 by the negative pressure in the suction hole 11.

Subsequently, in step (b) of FIG. 5, the wafer sheet 2 is moved in the opposite direction from the die feeding direction A so that the die 1A is positioned at the pickup center 5. Since the end portion of the die 1A has been peeled from the wafer sheet 2 as described above, the die 1A is peeled from the wafer sheet 2 by the vacuum suction force of the suction hole 12 when the die 1A is moved in step (a) and (b) of FIG. 5, so that the bonding strength between the wafer sheet 2 and the die 1A drops.

Subsequently, the steps (e) and (f) of FIG. 4 are performed.

In this fifth embodiment, as in the respective embodiments described above, since the bonding force between the wafer sheet 2 and the die 1A that is fed into the pickup center 5 has been lowered, the die 1A, which is thin, is not damaged even if the die 1A is pushed up by the die push-up member 21.

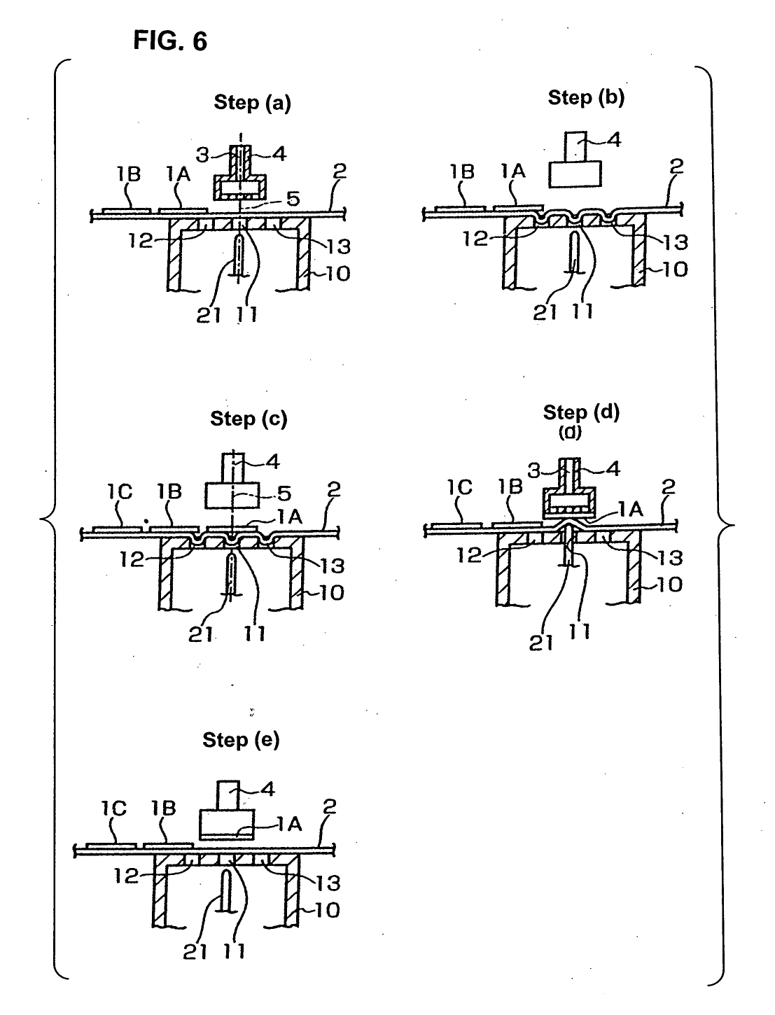

A fifth embodiment of the die pickup apparatus of the present invention will be described with reference to FIG. 6.

In this embodiment, as in the above-described third and fourth embodiments, a die push-up member 21 is disposed at the pickup center 5, and only suction holes 12 and 13 are disposed on both sides of the suction hole 11 of this die push-up member 21. Die push-up members 22 and 23 are not provided for the suction holes 12 and 13. In the fifth embodiment, the action of the die push-up member 21 differs from that in the above-described third and fourth embodiments.

The die pickup method of the fifth embodiment will be described below.

In step (a), the wafer sheet 2 is moved in the die moving direction (to the right in FIG. 6) so that the end portion (leading edge portion) (with respect to the die feeding direction) of the die 1A is moved to above the suction hole 12, and the vacuum of the suction holding stage 10 is switched on.

As a result, in the next step (b), the wafer sheet 2 is pulled downward at the end portion (with respect to the die feeding direction) of the die 1A by the vacuum suction of the suction holding stage 10, so that the die end portion of the die 1A is peeled from the wafer sheet 2.

Next, in step (c), the wafer sheet 2 is moved further right so that the center of the die 1A is positioned at the pickup center 5. Since the end portion (with respect to the die feeding direction) of the die 1A has been peeled from the wafer sheet 2 as described above, the die 1A is peeled from the wafer sheet 2 by the vacuum suction force of the suction hole 12 when the die 1A is moved in step (b) and step (c), and the bonding strength between the wafer sheet 2 and the die 1A drops.

Subsequently, the steps (d) and (e) are performed. Since these steps are the same as steps (e) and (f) of FIG. 4, the description is omitted here.

In this embodiment as well, as in the previous embodiments, since the bonding strength between the wafer sheet 2 and the die 1A that is fed into the pickup center 5 has been lowered, the die 1A, which is thin, is not damaged when the die 1A is pushed up by the die push-up member 21.

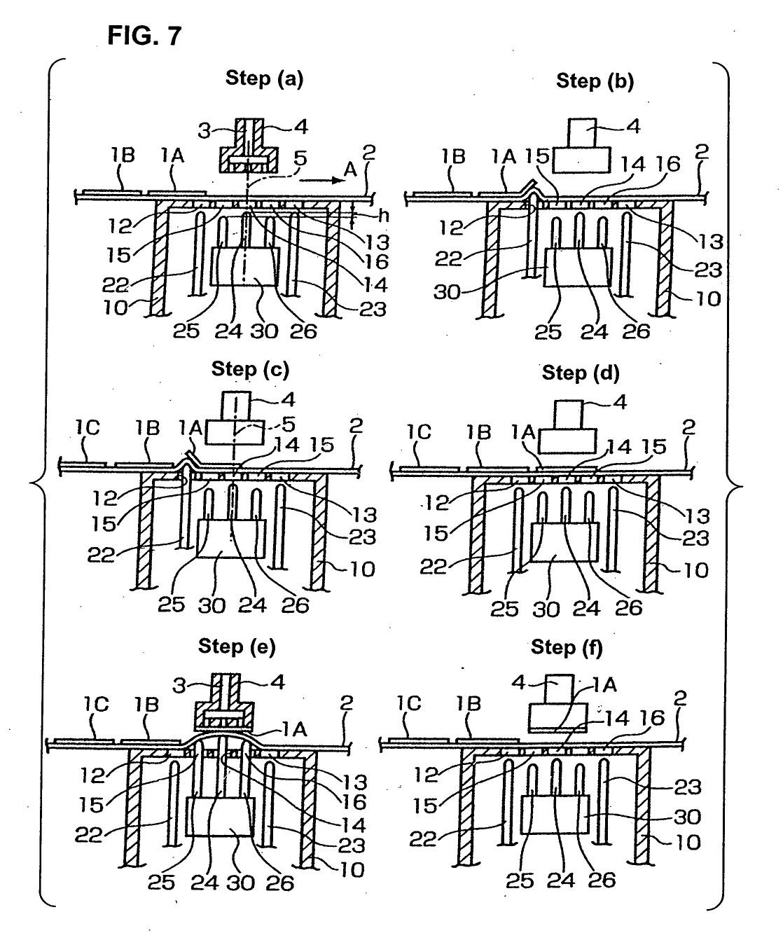

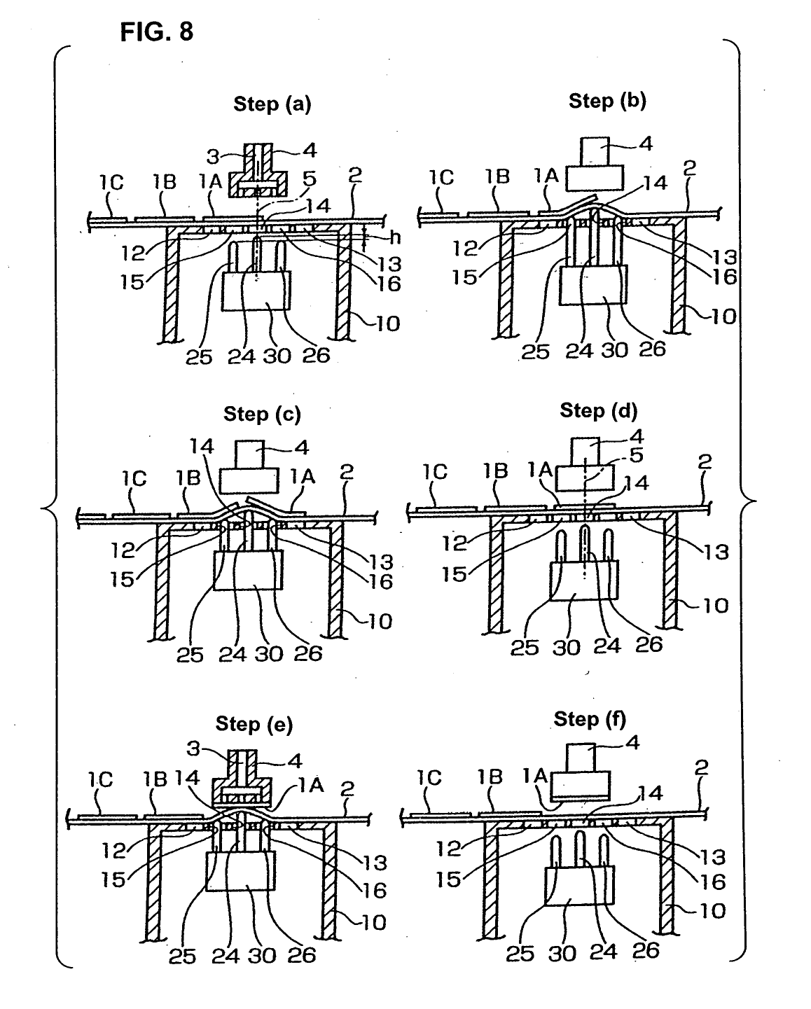

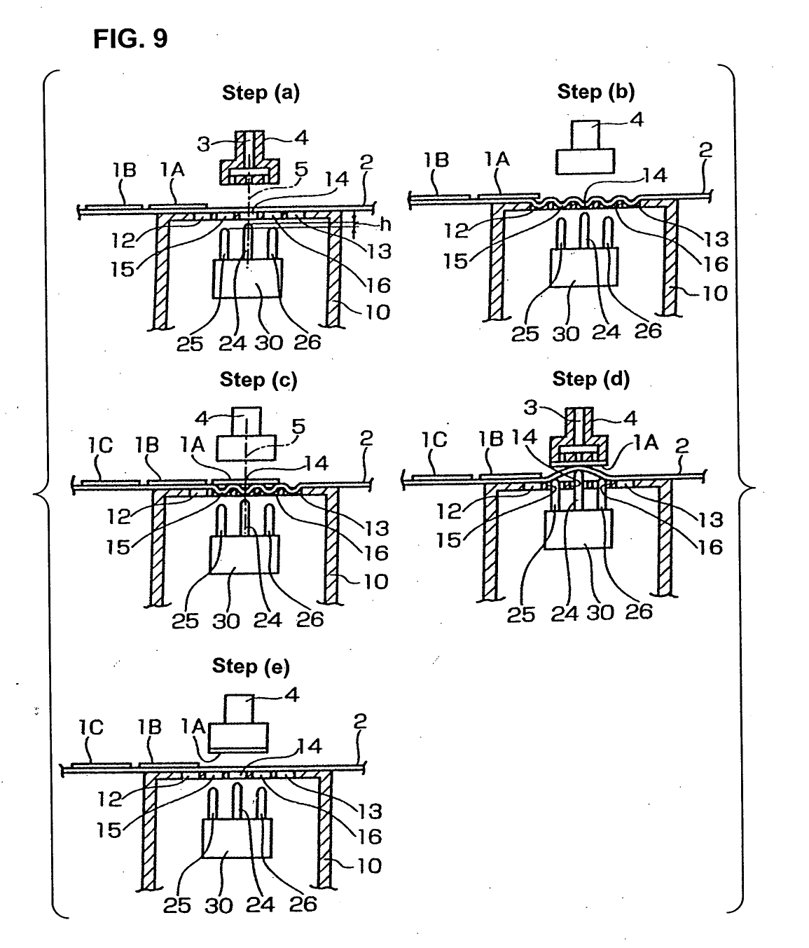

In the respective embodiments described above, a single die push-up member 21 is used for die-pickup. In the sixth, seventh and eighth embodiments shown in FIGS. 7, 8 and 9, three die push-up members 24, 25 and 26 used for die-pickup are employed. The example of FIG. 7 is a modification of the first embodiment shown in FIG. 1, the example of FIG. 8 is a modification of the third embodiment shown in FIG. 4, and the example of FIG. 9 is a modification of the fifth embodiment shown in FIG. 6.

In the embodiments shown in FIGS. 7, 8 and 9, the die push-up members 24, 25 and 26 are provided on a holder 30 which is driven upward and downward by a raising and lowering driving means which is not shown in the drawings, and the central die push-up member 24 is formed with a height that is higher than the other two die push-up members 25 and 26 which are on both sides of the central die push-up member 24 by a height h (approximately 100 to 150 μm). Suction holes 14, 15 and 16 are formed in the suction holding stage 10 so that the suction holes 14, 15 and 16 correspond to the die push-up members 24, 25 and 26, respectively. The remaining constructions are the same as those in the above-described embodiments; accordingly, the same or corresponding members are labeled with the same symbols, and a detailed description of such elements is omitted.

The sixth embodiment of the die pickup apparatus of the present invention will be described with reference to FIG. 7.

This embodiment include the steps of the first embodiment shown in FIG. 1, and the action is substantially the same as that shown in FIG. 1; accordingly, a detailed description of the same action will be omitted. More specifically, steps (a), (b), (c) and (d) in FIG. 7 correspond to the steps (a), (b), (c) and (d) of FIG. 1; here, only the die push-up member 22 is raised and lowered, and the die 1A is fed as shown in FIG. 1; and the bonding strength between the wafer sheet 2 and die 1A has dropped in step (d).

After the steps (a), (b), (c) and (d), the holder 30 is, in step (e), raised so that the die 1A is pushed upward by the die push-up members 24, 25 and 26, and the collet 4 holds the die 1A by vacuum suction. In this case, since the bonding strength between the wafer sheet 2 and the die 1A has been lowered, as in the case of FIG. 1, the die 1A can easily be peeled from the wafer sheet 2 by the upward movement of the die push-up members 24, 25 and 26 without being damaged. In this embodiment of FIG. 7, since the die 1A is pushed upward by the three die push-up members 24, 25 and 26, no excessive force is applied to the die 1A; moreover, even if the die is tilted by being pushed upward by the central die push-up member 24, the die is supported by one of the die push-up members 25 and 26 and held by suction-holding by the collet 4 through the vacuum suction of the suction holding hole 3 of the collet 4.

Subsequently, in step (f), the die push-up members 24, 25 and 26 are lowered by the holder 30, and the collet 4 that holds the die 1A by suction-holding makes predetermined operations. In addition, as in the process of FIG. 1, the wafer sheet 2 is moved so that the end portion (leading edge portion) of the die 1B that is to be picked up next is moved to above the die push-up member 22 as described above.

The seventh embodiment of the die pickup apparatus of the present invention will be described with reference to FIG. 8. This embodiment includes the steps of the embodiment shown in FIG. 4.

In step (a) of FIG. 8, the vacuum of the suction holding stage 10 is switched on, and the wafer sheet 2 is moved so that the end portion (leading edge portion) (with respect to the die feeding direction A) of the die 1A that is to be picked up is moved to above the central die push-up member 24.

Next, in step (b), the holder 30 is raised; as a result, the die push-up member 24 pushes the end portion (with respect to the die feeding direction) of the die 1A upward via the wafer sheet 2, and the end portion (with respect to the die feeding direction) of the die 1A is peeled from the wafer sheet 2.

Next, in step (c), with the holder 30, i.e., the die push-up member 24, in a raised state, the wafer sheet 2 is moved in the die feeding direction so that the die 1A rides over the die push-up member 24. When the die 1A thus passes over the die push-up member 24, the die 1A is fed so that it rides over the peak portion that is pushed upward by the die push-up member 24; accordingly, the bonding strength between the wafer sheet 2 and die 1A drops.

Subsequently, in step (d), the holder 30 is lowered, and the wafer sheet 2 is then caused to move so that the die 1A is positioned at the pickup center 5.

Then, in step (e), the holder 30 is raised so that the die push-up members 24, 25 and 26 push the die 1A upward, and the collet 4 holds the die 1A by vacuum suction. In this case, since the bonding strength between the wafer sheet 2 and die 1A has been lowered, the die 1A can easily be peeled from the wafer sheet 2 by the upward movement of the die push-up members 24, 25 and 26 without being damaged (in the same manner as in the embodiment of FIG. 4). Furthermore, in this embodiment of FIG. 8, since the die 1A is pushed upward by the three die push-up members 24, 25 and 26, no excessive force is applied to the die 1A; and even if the die is tilted by being pushed upward by the central die push-up member 24, the die is supported by one of the die push-up members 25 and 26 and held by suction-holding by the collet 4 through the vacuum suction of the suction holding hole 3 of the collet 4.

Subsequently, in step (f), the die push-up members 24, 25 and 26 are lowered by the holder 30, and the collet 4 holding the die 1A by suction-holding makes predetermined operations. In addition, the wafer sheet 2 is moved so that the end portion (leading edge portion) of the die 1B that is to be picked up next is moved to above the die push-up member 22 as described above as in the same manner as in the process of FIG. 1.

The eighth embodiment of the die pickup apparatus of the present invention will be described with reference to FIG. 9.

This embodiment includes some steps of the fifth embodiment shown in FIG. 6, and the operation is substantially the same as that in FIG. 6; accordingly, a detailed description of the same operation will be omitted.

More specifically, steps (a), (b) and (c) that correspond to the steps (a), (b) and (c) of FIG. 6 are performed, and thus the bonding strength between the wafer sheet 2 and the die 1A has been lowered in step (c).

Next, in step (d), the holder 30 is raised so that the die push-up members 24, 25 and 26 push the die 1A upward, and the collet 4 holds the die 1A by vacuum suction. In this case, since the bonding strength between the wafer sheet 2 and the die 1A has been lowered, the die 1A can easily be peeled from the wafer sheet 2 by the upward movement of the die push-up members 24, 25 and 26 without being damaged in the same manner as in the embodiment of FIG. 6). Furthermore, in the eighth embodiment of FIG. 9, since the die 1A is pushed upward by the three die push-up members 24, 25 and 26, no excessive force is applied to the die 1A; and even if the die is tilted by being pushed upward by the central die push-up member 24, the die is supported by one of the die push-up members 25 and 26 and is held by suction-holding by the collet 4 through the vacuum suction of the suction holding hole 3 of the collet 4.

Subsequently, in step (e), the die push-up members 24, 25 and 26 are lowered by the holder 30, and the collet 4 that holds the die 1A by suction-holding makes predetermined operations. Furthermore, the wafer sheet 2 is moved so that the end portion (leading edge portion) of the die 1B that is to be picked up next is moved to above the suction hole 12 in the same manner as in the process of FIG. 6.

In the first and sixth embodiments shown in FIGS. 1 and 7, when the entire die 1A is peeled away in steps (b) and (c) in FIGS. 1 and 7 while the die push-up member 22 is raised, the die 1A could slip off of the wafer sheet 2. This, however, can be prevented by way of lowering the die push-up member 22 before the rear end portion (with respect to the die feeding direction) of the die 1A is peeled from the wafer sheet 2. The same is true in the third embodiment shown in FIG. 4. In other words, in step (b) of FIG. 4 in which the wafer sheet 2, that is, the die 1A, is moved with the die push-up member 21 raised, the die push-up member 21 can be lowered before the die 1A is entirely separated from the wafer sheet 2.

Furthermore, in the present invention, after the end portion (leading edge portion) (with respect to the die feeding direction) of the die 1A is raised by the die push-up member 22 in steps (b) of FIGS. 1 and 7, the movement of the wafer sheet 2 can be stopped for 100 to 200 msec. This allows the die 1A to be peeled from the wafer sheet 2 easier.

In the present invention, in cases where the end portion (with respect to the die feeding direction) of the die 1A is pushed upward by the die push-up member 22 in steps (b) in FIGS. 1 and 7, the forward portion of the die 1A is more easily peeled by way of increasing the amount of protrusion of the die push-up member 22 from the upper surface of the suction holding stage 10. This protrusion amount can be set at, for instance, 250 μm. However, when the wafer sheet 2, i.e.; the die 1A, is moved under such a large amount of protrusion, there is a danger that the die 1A is damaged. In order to avoid this, it is preferable to lower the die push-up member 22 slightly following the steps (b) in the process of FIGS. 1 and 7. The amount of protrusion from the upper surface of the suction holding stage 10 can be set at, for instance, 100 μm. This is also true in the embodiment of FIG. 4. In other words, in step (b) in FIG. 4, the amount of protrusion of the die push-up member 21 from the upper surface of the suction holding stage 10 is set to be a large amount, and the die push-up member 21 is subsequently lowered by a slight amount.

The die push-up members 24, 25 and 26 used for die-pickup in the embodiments shown in FIGS. 7 and 9 have only the action of pushing up the die 1A (whose bonding strength with respect to the wafer sheet 2 has already been lowered) and causing this die 1A to be suction-held by the collet 4; accordingly, the die push-up members 24, 25 and 26 may all have the same height. However, in the embodiment shown in FIG. 8, the central die push-up member 24 functions to lower the bonding strength of the die with respect to the wafer sheet 2. Accordingly, in this embodiment, the die push-up member 24 must be formed with a height that is greater than the height of at least the die push-up member 25.

Furthermore, in the embodiments shown in FIGS. 7 through 9, three die push-up members 24, 25 and 26 are provided. However, the number of die push-up members used for die-pickup can be two or four or more. Furthermore, though this is not shown in the drawings, it goes without saying that the embodiment shown in FIG. 7 is applicable to the embodiment shown in FIG. 3 and the embodiment shown in FIG. 8 is applicable to the embodiment shown in FIG. 5.

1-7. (canceled)

8. A die pickup method comprising the steps of:
positioning a center of a die, with respect to a die feeding direction, to a die pickup center;
moving an end portion, with respect to the die feeding direction, of a die to be picked up to the pickup center;
suction-holding, on a suction holding stage by vacuum, a wafer sheet, which has dies adhering thereon, from a lower side of the wafer sheet;
peeling a part of the wafer sheet at an end of die in a die feeding direction side by raising a die push-up member;
conveying, with the die push-up member kept raised, the wafer sheet until a die end that is on an opposite side from the die feeding direction passes over the die push-up member, thereby weakening adhesive force of the die for the wafer sheet;
lowering the die push-up member;
releasing vacuum on the wafer sheet which is suction-held;
positioning the center of the die, with respect to the die feeding direction, to the die pickup center; and
raising another die push-up member and lowering a collet so that the collet picks up the die by suction-holding.

9. The die pickup method according to claim 8, wherein:—
a number of suction holes provided in the suction holding stage for suction-holding the wafer sheet, which has dies adhering thereon, from the lower side of the wafer sheet, is equal to or greater than the number of the push-up member.

10. The die pickup method according to claim 8, wherein:
during positioning the center of a die in the die feeding direction, the die pick-up center and a center of tip end of the die push-up pin coincide.

11. The die pickup method according to claim 10, wherein:
three die push-up members are provided, and a die push-up member at a center of the three die push-up members is higher than other two die push-up members.

12. The die pickup method according to claim 11, wherein:
the die push-up members are provided on a holder which is driven upward and downward by a raising and lowering driving means.

13. The die pickup method according to claim 8, the method being used in a die pickup apparatus comprising:
a suction holding stage for suction-holding a wafer sheet which has dies adhering thereon;
a die push-up member provided in a pickup center within the suction holding stage and used for die pickup, the die push-up member pushing up a die;
a collet for suction-holding and conveying a die which is pushed up by the die push-up member used for die pickup; and
a suction hole provided in the suction holding stage, the suction hole being used when the wafer sheet, which has dies adhering thereon, is suction-held by vacuum from a lower side of the wafer sheet.

14. The die pickup method according to claim 13, wherein:
a number of suction holes provided in the suction holding stage for suction-holding the wafer sheet, which has dies adhering thereon, from the lower side of the wafer sheet, is equal to or greater than the number of the push-up member.

15. The die pickup method according to claim 13, wherein:
during positioning a center of a die in the feeding direction, the die pick-up center and a center of tip end of the die push-up pin coincide.

16. The die pickup method according to claim 15, wherein:
three die push-up members are provided, and a die push-up member at a center of the three die push-up members is higher than other two die push-up members.

17. The die pickup method according to claim 16, wherein:
the die push-up members are provided on a holder which is driven upward and downward by a raising and lowering driving means.
